(19) United States
(12) Patent Application Publication
(10) Pub. No.: US 2026/0209451 A1
(43) Pub. Date: Jul. 23, 2026

(54) BIODEGRADABLE AND BARRIER PVOH-BASED MATERIALS AND PRODUCTS MADE THEREFROM

(71) Applicant: SOLUTUM TECHNOLOGIES LTD., Tel Aviv (IL)

(72) Inventors: Noura SADER, Haifa (IL); Yarden MOSHE DAVID, Afula (IL); Regev BEN ZVI BECHLER, Rehovot (IL)

(73) Assignee: SOLUTUM TECHNOLOGIES LTD., Tel Aviv (IL)

(21) Appl. No.: 19/138,708

(22) PCT Filed: Dec. 26, 2023
(86) PCT No.: PCT/IL2023/051310

§ 371 Date: Jun. 13, 2025

Related U.S. Application Data
(60) Provisional application No. 63/477,289, filed on Dec. 27, 2022.

(51) Int. Cl. C08J 5/18; B29C 48/08; B29K 229/00; B29L 7/00; C08K 5/053; C08K 5/092; C08K 5/098; C08L 29/04

(52) U.S. Cl. CPC C08J 5/18; B29C 48/08; C08K 5/053; C08K 5/092; C08K 5/098; C08L 29/04; B29K 2229/04; B29K 2823/16; B29K 2995/006; B29L 2007/008; C08J 2329/04; C08L 2201/06; C08L 2203/16

(57) ABSTRACT

The invention includes compositions and processes for manufacturing biodegradable polymeric-based materials exhibiting water-resistant and barrier properties.

### TECHNOLOGICAL FIELD

The invention generally contemplates compositions and processes for manufacturing biodegradable polymeric-based materials exhibiting barrier properties.

### BACKGROUND OF THE INVENTION

Biodegradable or water-soluble polymeric films are environmentally friendly and more often used as novel packaging materials. Some are used as functional packaging materials set to undergo purposed biodegradation in contact with water, soil or compost; others are timed to biodegrade within a period of time.

Poly(vinyl alcohol) (PVOH) coatings and films have been used as laminates to various substrates and have demonstrated barriers properties to the transmission of oxygen, water vapor, grease and oils. However, PVOH is soluble in water and is known to gradually dissolve and biodegrade in the presence of appropriate microorganisms. While attempts to reduce, prevent or diminish its dissolution in the presence of humidity have been partially successful, attempts to time its dissolution or biodegradability have substantially failed.

### GENERAL DESCRIPTION

Biodegradable materials that demonstrate effective biodegradation in water and in the presence of appropriate microorganisms, and which maintain high or improved water resistance are not known. This is so since improving biodegradation typically reduces water resistance and vice versa. The incentive of the inventors of the technology disclosed herein has been to marry both properties in a single polymeric material to exhibit improved water resistance while maintaining rapid biodegradation. As high-water resistance and good oxygen barrier are properties that typically correlate with high crystallinity and are thus contradictory to the improved biodegradability, the inventors' developments disclosed herein have been highly surprising.

One of the methods available for increasing water resistance of water-sensitive polymers, such as PVOH, to moisture is to crosslink the polymer. However, for maintaining both biodegradability and water resistance, crosslinking alone does not suffice. This is so as crosslinking will increase water resistance and at the same time reduce biodegradability. The inventors have now realized and herein demonstrate that crosslinking an un-crosslinked PVOH, which may be of any type, grade or molecular weight, with ethylene-polyvinyl alcohol copolymer produces a polymer material with superior biodegradation, increased water resistance, low coefficient of friction and low tackiness, as compared to PVOH alone and as compared to highly biodegradable materials, such as cellulose, known and used as standard for biodegradation and water solubility tests. The presence of the ethylene-polyvinyl alcohol copolymer with the PVOH also improves processability of the compositions during compounding, allowing to significantly reduce the content of plasticizer.

Thus, the invention contemplates a composition comprising polyvinyl alcohol (PVOH) and ethylene-polyvinyl alcohol copolymer (E-PVA) for manufacturing a polymer demonstrating biodegradability in the presence of water, water resistance over time, and oxygen barrier properties (described herein in terms of oxygen transmittance rate, OTR).

In a first of its aspects, the invention provides a composition comprising polyvinyl alcohol (PVOH), ethylene-polyvinyl alcohol copolymer (E-PVA), a plasticizer and optionally a crosslinking agent. In some embodiments, the composition may further comprise at least one additive.

The invention further provides a compounded composition formed of a blend of polyvinyl alcohol (PVOH), ethylene-polyvinyl alcohol copolymer (E-PVA), a plasticizer and optional at least one additive. The compounded form of the composition may be provided in a solid form, e.g., a pelletized form. The compounded form may also be a crosslinked product of polyvinyl alcohol (PVOH), ethylene-polyvinyl alcohol copolymer (E-PVA), and in some embodiments, crosslinked also with the plasticizer, achieved by crosslinking with at least one crosslinking agent. Where the crosslinked product does not involve crosslinking of the plasticizer, the compounded form may also include the plasticizer and at least one additive.

The invention further provides a composition for use in a process of manufacturing a thermoplastic polymer, the composition comprising polyvinyl alcohol (PVOH), ethylene-polyvinyl alcohol copolymer (E-PVA), a plasticizer and optionally a crosslinking agent.

Also provided is a thermoplastic PVOH/E-PVA polymer being a blend or an optionally crosslinked product of PVOH and ethylene-polyvinyl alcohol copolymer, the polymer being biodegradable in water, water resistant over time, and having good oxygen barrier properties.

As used herein, the term “biodegradation” or any lingual variation thereof refers to the ability of the polymer to degrade in the presence of water, under the conditions of, for example, ISO14851 or ISO14852. The biodegradation of a polymer of the invention is tested in water and compared with a sample of a polymer having no E-PVA or less than molar % of E-PVA, tested under the same conditions over the same period of time.

The biodegradation of a polymer of the invention, formed as disclosed herein, either as a blend of the materials or as a crosslinked polymer, was measured as compared to cellulose as a standard for high water solubility and as compared to PVOH (not containing E-PVA or less than 10% E-PVA). As demonstrated herein, polymers formed according to the invention demonstrated an increase in biodegradation, as compared to PVOH alone, that was at least 20% greater. In other words, the amount of the polymer biodegrading over time was greater than the amount of PVOH biodegraded over the same degradation period.

The biodegradation in percent (%) values reflects the total weight amount degraded under standard measurements conditions acceptable in the industry, as noted above. The test is performed on finely ground powder of the composition and is expressed as O₂ consumed or CO₂ evolved with respect to theoretical oxygen demand (THOD) or theoretical total organic content (TOC) theoretical.

In some embodiments, products of the invention demonstrated improved biodegradation of at least 20%, when measured according to ISO14851 or ISO14852, as compared with biodegradation of PVOH-based products (not containing E-PVA), measured under identical conditions. In some embodiments, the improvement is by 20, 25, 30, 35, 40, 45, 50, 55, 60 or 65%.

The “water resistance over time” refers to the time required to deform a film formed of a composition of the invention after 3 drops of water (each drop ~100-110 μl) are sequentially dropped on a 50-micron film that is placed in a horizontal position. The time until the film starts deforming is measured, in seconds or minutes. As demonstrated in Table 1, the reference composition comprising no E-PVA showed a very low resistance to water and deformed within less than 15 seconds, whereas the comparable formulations that include E-PVA, e.g., at least 20% by weight of E-PVA, exhibit deformation a much longer period of time, e.g., after more than 15 minutes, following exposure to the water drops placed on the films. Thus, in the context of the present invention, the water resistance is defined, for purposes herein, as the time it takes to achieve deformation of a 50-micron film formed of the material, when exposed to three drops of water. Other film thicknesses may be used. Other methods or tests of determining water resistance may be utilized.

Oxygen transmission rate (OTR) is a rate at which oxygen gas traverses through a solid material over a given time period. Solid materials that are considered effective oxygen barriers exhibit OTR values that are between 10 and less than 1 cm³/m²*day, when measured at medium to high relative humidity (RH).

As demonstrated herein, at 50% RH, a 50-micron film formed of formulations free of E-PVA exhibited OTR values greater than 10 cm³/m²*day, while for equivalent formulations according to the invention, with E-PVA (as tested with at least 15% of E-PVA), the OTR values recorded were between 6 cm³/m²*day and 0.9 cm³/m²*day. Similarly, at 65% RH, OTR values dropped from ~90 cm³/m²*day for a formulation free of E-PVA between 43 cm³/m²*day and 10 cm³/m²*day.

The amount of each component of a composition of the invention may vary. The amount depends, inter alia, on the eventual polymer formed from the composition, the desired polymer properties and the attribute which is to be enhanced or minimized. Generally speaking, all compositions of the invention comprise the components disclosed in amounts that allow for (1) increased biodegradability in the presence of water, at least 15% improved in terms of % absolute biodegradation (absolute biodegradation is defined as the % of biodegradation when the materials reaches a plateau, as illustrated in FIG. 1) when the material has been tested according to ISO14851 or ISO14852 (2) increased water resistance, e.g., increased from ≤30 seconds to >60 seconds when tested in accordance with the method described herein, and (3) enhanced or high oxygen barrier properties in particular at least a 50% reduction in OTR for a defined film thickness when E-PVA is present at an amount that is at least 15%, all of these properties relative to comparable PVOH compositions without the EPVA copolymer.

The “PVOH” used according to the invention is polyvinyl alcohol which may be made by saponification of polyvinyl acetate homopolymers or copolymers or which may be synthetically or semi-synthetically produced. The PVOH may be of any grade, degree of hydrolysis and molecular weight. The PVOH used in compositions of the invention may be a crosslinked PVOH or an un-crosslinked PVOH. In some configurations where the PVOH is un-crosslinked, the PVOH may be selected amongst such water-soluble materials comprising predominantly fully, partially or sub-partially hydrolyzed vinyl organic ester polymers, which are not internally associated or linked.

In some embodiments, the PVOH is un-crosslinked. In some embodiments, compositions of the invention exclude crosslinked PVOH.

The PVOH may be provided as a single grade of PVOH or a combination of grades. The PVOH is typically selected amongst hydrolyzed PVOH having a degree of hydrolysis ranging between 86 and 99%. The PVOH may alternatively or additionally be selected amongst such having a degree of polymerization ranging between 500 and 3,000.

The PVOH may be a partially hydrolyzed PVOH with a degree of polymerization between 300 and 2,000. In some embodiments, the PVOH is selected to have a degree of polymerization between 800 and 1400 or a molecular weight between 30 KDa and 70 KDa or a molecular weight between 35 KDa and 62 KDa.

In some embodiments, the PVOH is selected amongst PVOH having a degree of hydrolysis between 98 and 99% and a degree of polymerization of between about 800 and 1,700; a degree of hydrolysis between 86 and 89% and a degree of polymerization of between about 1400 and 2,600; and a degree of hydrolysis between 86 and 89% and a degree of polymerization of between 500 and 800.

In some embodiments, the PVOH may be selected amongst one or more of the following grades:
(i) Grade 1: partially hydrolyzed grade having a degree of hydrolysis from 86 to 90 mol % and a degree of polymerization (DP) of between 300 and 2000, or between 500 and 1400, e.g., 500, 800, or 1400,
(ii) Grade 2: medium hydrolyzed grade having a degree of hydrolysis between 91 and 97%, and
(iii) Grade 3: fully hydrolyzed grade having a degree of hydrolysis from 98% to >99% (or 100%) and a degree of polymerization of between 300 and 2000, or 500 and 1700, e.g., 1700.

The amount of the PVOH used may be between 40 and 90 wt % (relative to the total weight of the composition). In some embodiments, the amount of the PVOH is between 40 and 90, 40 and 85, 40 and 80, 40 and 75, 40 and 70, 40 and 65, 40 and 60, 40 and 55, 40 and 50, 40 and 45, 45 and 90, 45 and 85, 45 and 80, 45 and 75, 45 and 70, 45 and 65, 45 and 60, 45 and 55, 50 and 90, 50 and 85, 50 and 80, 50 and 75, 50 and 65, 50 and 60, 60 and 90, 60 and 80, 70 and 90, or between 80 and 90 wt %.

The ethylene-polyvinyl alcohol copolymer (or E-PVA in short) is a polyvinyl alcohol copolymer with ethylene as a co-monomer. The material is known also as ethylene modified polyvinyl alcohol, or ethylene modified copolymer PVOH.

The E-PVA is a copolymerization product of hydrophobic ethylene monomers (E) with hydrophilic PVOH, and is more hydrophobic than PVOH, with significantly reduced humidity absorption at average temperatures. In addition to its reduced humidity absorption, the material is also characterized by a higher water resistance and good gas barrier properties which, unlike regular PVOH, preserved better at high humidity.

The content of ethylene in the E-PVA copolymer may vary. Typically, compositions of the invention may include E-PVA having an ethylene content not exceeding 15 molar %. In some embodiments, the ethylene content is different than zero, yet is smaller than 15, 14, 13, 12, 11, 10, 9, 8, 7, 6, 5, 4, 3 or 2% of said E-PVA. The ethylene content may be between 1 and 15 molar % and in some other embodiments, the ethylene content may be between 2 and 15, 3 and 15, 4 and 15, 5 and 15, 6 and 15, 7 and 15, 8 and 15, 9 and 15, 10 and 15, 11 and 15, 12 and 15, 5 and 10, 6 and 10, 7 and 10, 8 and 10, 5 and 9, 5 and 8 or 5 and 7 molar %.

Degree of polymerization (DP) and degree of hydrolysis (DH) of the E-PVA may vary as well. Typically, compositions of the invention may include E-PVA having a DP between 300 and 2,000 and/or a DH between 86 and 99.6%.

Generally, the E-PVA may be provided in different grades. The grades may differ from one another in the E-PVA degree of hydrolysis. The grades are:
1) Grade 1: a degree of polymerization (DP) between 300 and 800;
2) Grade 2: a degree of polymerization (DP) between 800 and 1500;
3) Grade 3: a degree of polymerization (DP) between 1500 and 2000.

The degree of hydrolysis for all grades of E-PVA may be between 86 and 99.6 mol %, or between 92 and 99.6 mol %, or between 94 and 99.6 mol %, or between 96 and 99.6 mol %, or between 98 and 99.6 mol %, wherein each value between 86 and 99.6 mol % constitutes a separate embodiment.

In some embodiments, the E-PVA may be selected amongst such having a DP between 300 and 2,000, 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000.

In some embodiments, the E-PVA may be selected from E-PVA of Grade 1, Grade 2 or Grade 3, as defined herein.

In some embodiments, the E-PVA may be selected amongst such having a DH of between 86 and 99.5%, 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5%.

In some embodiments, the E-PVA is selected from E-PVA having a DH from 86 to 90% and a DP of between 300 and 2,000.

In some embodiments, the E-PVA is selected from E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000 (wherein each value or range constitutes a separate and an independent embodiment) and a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5% (wherein each value or range constitutes a separate and an independent embodiment). Any combination of DP and DH from the above constitutes a separate and independent embodiment.

In some embodiments, compositions and polymers of the invention are formed of PVOH of Grade 1, as defined herein, and E-PVA of Grade 1, 2, and/or 3.

In some embodiments, compositions and polymers of the invention are formed of PVOH of Grade 2, as defined herein, and E-PVA of Grade 1, 2, and/or 3.

In some embodiments, compositions and polymers of the invention are formed of PVOH of Grade 3, as defined herein, and E-PVA of Grade 1, 2, and/or 3.

In some embodiments, compositions and polymers of the invention are formed of PVOH of one or more of Grades 1, 2 or 3, as defined herein, and E-PVA of Grade 1.

In some embodiments, compositions and polymers of the invention are formed of PVOH of one or more of Grades 1, 2 or 3, as defined herein, and E-PVA of Grade 2.

In some embodiments, compositions and polymers of the invention are formed of PVOH of one or more of Grades 1, 2 or 3, as defined herein, and E-PVA of Grade 3.

In some embodiments, compositions and polymers of the invention are formed of:
I) PVOH selected from one or more of the following grades:
   (i) partially hydrolyzed grades having a degree of hydrolysis from 86 to 90% and a degree of polymerization (DP) of between 300 and 2000, or between 500 and 1400, e.g., 500, 800, or 1400,
   (ii) medium hydrolyzed grades having a degree of hydrolysis between 91 and 97%, and
   (iii) fully hydrolyzed grades having a degree of hydrolysis from 98% to >99% (or 100%) and a degree of polymerization of between 300 and 2000, or 500 and 1700, e.g., 1700; and
II) E-PVA selected from:
   (i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000 (wherein each value or range constitutes a separate and an independent embodiment) and
   (ii) a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5% (wherein each value or range constitutes a separate and an independent embodiment). Any combination of DP and DH from the above constitutes a separate and independent embodiment.

In some embodiments, compositions and polymers of the invention are formed of:
I) PVOH being a partially hydrolyzed grade having a degree of hydrolysis from 86 to 90% and a degree of polymerization (DP) of between 300 and 2000, or between 500 and 1400, e.g., 500, 800, or 1400, and
II) E-PVA selected from:
   (i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000 (wherein each value or range constitutes a separate and an independent embodiment) and
   (ii) a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5% (wherein each value or range constitutes a separate and an independent embodiment). Any combination of DP and DH from the above constitutes a separate and independent embodiment.

In some embodiments, compositions and polymers of the invention are formed of:
I) PVOH being a medium hydrolyzed grade having a degree of hydrolysis between 91 and 97%, and
II) E-PVA selected from:
   (i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000 (wherein each value or range constitutes a separate and an independent embodiment) and
   (ii) a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5% (wherein each value or range constitutes a separate and an independent embodiment). Any combination of DP and DH from the above constitutes a separate and independent embodiment.

In some embodiments, compositions and polymers of the invention are formed of:
I) PVOH being a fully hydrolyzed grade having a degree of hydrolysis from 98% to >99% (or 100%) and a degree of polymerization of between 300 and 2000, or 500 and 1700, e.g., 1700; and
II) E-PVA selected from:
   (i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000 (wherein each value or range constitutes a separate and an independent embodiment) and
   (ii) a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5% (wherein each value or range constitutes a separate and an independent embodiment). Any combination of DP and DH from the above constitutes a separate and independent embodiment.

The amount of the E-PVA in the composition may vary. In some embodiments, the amount of the E-PVA is at most 60 wt %, relative to the total weight of the composition. In some embodiments, the amount of the E-PVA is at least 5 wt %, relative to the total weight of the composition.

In some embodiments, the amount of E-PVA is between 5 and 60, 5 and 55, 5 and 50, 5 and 45, 5 and 40, 5 and 35, 5 and 30, 5 and 25, 5 and 20, 5 and 15, 5 and 10, 10 and 60, 10 and 55, 10 and 50, 10 and 45, 10 and 40, 10 and 35, 10 and 30, 10 and 25, 10 and 20, 20 and 60, 20 and 50, 20 and 40, 20 and 30, 30 and 60, 30 and 50, 40 and 60, or between 40 and 50 wt %.

In some embodiments, the amount of E-PVA in a composition of the invention is between 5 and 10, 10 and 60, 10 and 55, 10 and 50, 10 and 45, 10 and 40, 10 and 35, 10 and 30, 10 and 25, or between 10 and 20 wt %.

The “plasticizer” present in compositions of the invention is one or more of such compounds used to increase fluidity or plasticity of the polymeric composition of the invention. The at least one plasticizer is selected amongst such materials capable of reducing the glass transition temperature and/or melting point of the polymeric composition under melt extrusion. Without wishing to be bound by theory, the plasticizer used may also decrease the melt viscosity of the melted composition, tensile strength, hardness, density and increase parameters such as elongation at break, toughness and dielectric constant.

The at least one plasticizer used is generally compatible with PVOH and which is stable under hot melt extrusion conditions and sufficiently lubricating and stable in the final compounding product and film. The at least one plasticizer may be one or more plasticizer selected from sorbitol, maltitol, mannitol, glycerol, erythritol, dipropylene glycol, triethylene glycol, tetraethylene glycol (TEG), triethanolamine (TEA), trimethylol propane, penta-erythritol, dipentaerythritol, dibutyl sebacate (DBS), polyglyceryl-4 laurate, ditrimethylol propane, urea, diglycerol, xylitol, acetyltributyl-citrate (ATBC), polyethylene glycol, triethylcitrate, vitamin E TPGS (d-α-tocopherol peg-1000 succinate), ethylene glycol, diethylene glycol, 1,2,4-butanetriol, epoxidized soy bean oil, ethoxylated glycerol and others.

In some embodiments, the at least one plasticizer may be selected from glycerol, sorbitol, a propylene glycol, a polyethylene glycol, and the like, and any combination thereof.

In some embodiments, the at least one plasticizer is glycerol and/or sorbitol.

In some embodiments, the at least one plasticizer is glycerol.

The amount of the plasticizer may be varied and kept down to a bare minimum. The amount of the plasticizer is typically no more than 20 wt %. In some cases, the minimum amount may be 1 wt % or below 1 wt %. In some embodiments, the amount of the plasticizer may be selected to be between 1 and 20 wt %, relative to the total weight of the composition.

In some embodiments, the amount of the plasticizer is between 1 and 20, 1 and 15, 1 and 10, 1 and 5, 1 and 4, 1 and 3, or 1 and 2 wt %, or the amount is 1, 2, 3, 4, 5, 6, 7, 8, 9 10, 15 or 20 wt %, relative to the total weight of the composition.

The weight ratio plasticizer to PVOH used may be such that the weight amount of PVOH is greater, e.g., twice, three times or more, than the weight amount of the plasticizer. In some embodiments, the ratio amount plasticizer:PVOH used may be between 1:2 to 1:20 (wt/wt). In some embodiments, the ratio is 1:10, 1:15, 1:20.

The invention further provides the following compositions exemplifying the breath of the invention disclosed:
Composition 1: PVOH Grade 1; EPVA Grade 1; glycerol; at a ratio 58:39:3 (or 60:40:3);
Composition 2: PVOH as a combination of PVOH Grade 1 and PVOH Grade 2; EPVA Grade 1; glycerol; PEG; at a ratio (47:32:15:3:3);
Composition 3: PVOH as a combination of PVOH Grade 1 and PVOH Grade 2; EPVA Grade 1; glycerol; PEG at a ratio (47:31:10:10:2);
Composition 4: PVOH Grade 1; EPVA Grade 1; glycerol; at a ratio 68:29:3;
Composition 5: PVOH Grade 1; EPVA Grade 1; glycerol; PEG; at a ratio 52:43:3:2;
Composition 6: PVOH Grade 2; EPVA Grade 2; glycerol; PEG; at a ratio 57:38:3:2;
Composition 7: PVOH as a combination of PVOH Grade 1 and PVOH Grade 2; EPVA Grade 1; glycerol; PEG; at a ratio 49:21:25:3:2;
Composition 8: PVOH as a combination of PVOH Grade 1 and PVOH Grade 2; EPVA Grade 1; glycerol; PEG; at a ratio 58:25:5:10:2;
Composition 9: PVOH as a combination of PVOH Grade 1 and PVOH Grade 2; E-PVA as a combination of EPVA Grade 1 and EPVA Grade 2; glycerol; at a ratio 35:22:25:15:3;
Composition 10: PVOH grade 2; EPVA grade 2; glycerol; at a ratio 49:48:3;
Composition 11: PVOH as a combination of PVOH Grade 1 and PVOH Grade 2; EPVA Grade 2; glycerol; PEG; at a ratio 15:59:20:3:3;
Composition 12: PVOH as a combination of PVOH Grade 1 and PVOH Grade 2; EPVA Grade 2; glycerol; PEG; at a ratio 71:18:5:5:1;
Composition 13: PVOH Grade 2; EPVA Grade 1; glycerol; PEG; at a ratio 73:20:5:2; and
Composition 14: PVOH as a combination of PVOH Grade 1 and PVOH Grade 2; E-PVA as a combination of EPVA Grade 1 and EPVA Grade 2; glycerol; PEG; at a ratio 35:35:15:10:3:2.

Compositions of the invention may or may not comprise a crosslinking agent. Typically, the crosslinking agent may be included in small amounts, typically small amounts or amounts below 1 wt % or below 0.5 wt %. In some embodiments, the amount of a crosslinking agent is between 0.03 and 0.5 wt %.

The crosslinking agent may be any such material capable of forming covalent bonds or chemical associations or chemical bridges between chains of PVOH, between PVOH and the ethylene-polyvinyl alcohol copolymer or between any two or more crosslinkable or polymerizable materials present in the composition (the PVOH, E-PVA, and/or plasticizer). Optionally, the crosslinking agent is selected amongst bifunctional or multifunctional materials.

The crosslinking agent may be selected from polymers, copolymers and nonpolymeric materials, each of which having a functionality capable of associating to OH functionality present on the PVOH backbone. The crosslinking or association is typically through the formation of covalent bonds. In other instances, the association may be physical, namely wherein chains of the polymers entangle. In some embodiments, the association is by formation of hydrogen bonding and/or ionic association. Notwithstanding the type of association, the crosslinking molecule is selected to provide an association which results in a desired physico-mechanical profile.

The functionality on the crosslinking compound, enabling association with the PVOH may be an inherent functionality of the compound, e.g., oligomer or polymer, or a functionality that is grafted or associated or appended with the compound to afford crosslinking capabilities. In some embodiments, the crosslinking compound is provided with functionality selected from alcohols, epoxides, anhydrides, carboxylic acids, amines, amides, glycidyl functionalities, aldehyde functionalities, esters and others. The crosslinking compound may be a polymer selected amongst ionomers, namely polymers having one or more functionalities capable of forming ionic groups. In some embodiments, the ionomer is a polyacid optionally selected from poly(acrylic acid) (PAA), poly(methacrylic acid) (PMAA) and others.

In some embodiments, the crosslinking compound is a polymer grafted with an anhydride such as maleic anhydride. In some embodiments, the polymer upon which the maleic anhydride is grafted may be selected from polyethylene (PE), poly(lactic acid) (PLA), polycaprolactone (PCL), polyhydroxybutyrate (PHB), poly(butylene adipate-co-terephthalate) (PBAT), polybutylene succinate (PBS) and others. In some embodiments, the crosslinking compound is polyethylene-graft-maleic anhydride.

In some embodiments, the crosslinking compound is a polymer produced by copolymerization with an anhydride such as maleic anhydride. In some embodiments, the polymer within which the maleic anhydride is introduced by copolymerization may be selected from polyethylene (PE), poly(lactic acid) (PLA), polycaprolactone (PCL), polyhydroxybutyrate (PHB), poly(butylene adipate-co-terephthalate) (PBAT), polybutylene succinate (PBS), polybutylene succinic adipate (PBSA), and others. In some embodiments, the crosslinking compound is a copolymer of ethylene and maleic anhydride.

In some embodiments, the crosslinking compound is a polymer having carboxylic acid functionalities. In some embodiments, the polymer is selected from poly(ethylene-co-acrylic acid) (PE-co-AA), poly(ethylene-co-methacrylic acid) (PE-co-MAA), poly(lactide-block-acrylic acid) (PLA-block-AA), PVOH with carboxylic groups, carboxymethyl cellulose (CMC) and others.

In some embodiments, the polymer is poly(ethylene-co-acrylic acid).

In some embodiments, the polymer is a polymer having glycidyl functionalities.

In some embodiments, the at least one crosslinking compound is a copolymer.

In some embodiments, the crosslinking compound is a low-molecular crosslinking compound that is not a polymer, an oligomer or a copolymer. In such embodiments, the compound is typically selected amongst aldehydic compound; carboxylic acid compounds; amine compounds; halogen substituted compounds; and others reactive in the presence of or towards the PVOH.

In some embodiments, the aldehyde compound may be selected amongst monoaldehydes and dialdehydes. In some embodiments, the aldehyde is selected from formaldehyde, glutaraldehyde, glyoxal, malondialdehyde, succindialdehyde, phthalaldehyde and others.

In some embodiments, the carboxylic acid compound is selected amongst monocarboxylic acids, dicarboxylic acids, tricarboxylic acids and higher homologues (having four or more carboxylic acid groups). These carboxylic acids may alternatively be selected based on the number of carboxylate or basic groups they can form. Thus, in an equivalent fashion, these compounds may be selected amongst monobasic acids, dibasic acids, tribasic acids and higher homologues (having four or more basic acids). In some embodiments, the carboxylic acid compound is selected from succinic acid, citric acid, boric acid, humic acid, phthalic acid, terephthalic acid, malic acid, sulfo-succinic acid, isophthalic acid, aconitic acid, fumaric acid, tartaric acid, 1,2,3,4-buthanetetracarboxylic acid (BTCA) and others.

In some embodiments, the crosslinking agent is selected from succinic acid, 1,2,3,4-buthanetetracarboxylic acid (BTCA), ethylene maleic anhydride copolymer, tartaric acid and others.

Compositions of the invention may comprise one or more additional agents or additives selected to impart the polymeric material formed therefrom with mechanical or chemical attributes. The one or more agents may be selected from plasticizers, softening agents, bioplastics, polysaccharides, aliphatic polyesters and copolymers thereof, aromatic polyesters and copolymers thereof, cellulose-based materials, inorganic additives, fillers, reinforcing materials, low-molecular weight additives (having a molecular weight below 3,000 Da), processing aids, slip agents, light stabilizers, UV absorbers, flame retardants, antimicrobial agents, antiviral agents, blowing agents, nucleating agents, antioxidants, antiblocking agents, antistatic agents, odor control agents, and others.

The bioplastic used in accordance with the invention is a polymer that is different from the other polymeric components used in the composition of the invention, all of which being substantially also bioplastics. The bioplastic may be represented by a natural polymer that is produced or derived from natural sources, such as cells of living organisms, plants and other natural sources. Such polymers may be fully natural or partially synthetic, namely derived from nature and chemically modified to structurally modify the natural polymer. The bioplastic used in accordance with the invention may be also represented by a biodegradable or compostable polymer which is partially or fully derived from petrochemical sources.

In some embodiments, the bioplastic is selected from polypeptides and polysaccharides. In some embodiments, the bioplastic is selected from aliphatic or aromatic polyesters, co-polyesters or polyesteramides. In some embodiments, the bioplastic is selected from poly(ethylene glycol) (PEG) including higher molecular weight poly(ethylene oxide) (PEO), polycaprolactone (PCL), poly(lactic acid) (PLA), cellulose and cellulose derivatives, starch, thermoplastic starch (TPS), chitosan, polyhydroxyalkanoates (PHAs) such as polyhydroxybutyrate (PHB), polybutylene adipate terephthalate (PBAT), polybutylene succinate (PBS) and polybutylene succinate adipate (PBSA).

The cellulose derivative is a crystalline derivative thereof or any other amorphic form of such a material. Non-limiting examples include nanocrystalline cellulose (NCC), microfibrillar cellulose, microcrystalline cellulose (MCC), bacterial cellulose (BC), hydroxypropylmethyl cellulose (HPMC), hydroxypropyl cellulose (HPC), hydroxyethyl cellulose (HEC) and carboxymethyl cellulose (CMC).

In some embodiments, the additive is a hygroscopic agent, optionally selected from CaO, CaCl₂, LiCl, NaCl, CaI₂, MgCl₂, TiO₂, CaCO₃, alumina silicate fillers, SiO₂ and others. In some embodiments, the additive is CaO.

In some embodiments, the additive is an inorganic salt comprising a metallic or a non-metallic element. In some embodiments, the inorganic salt is an inorganic salt of a metal selected from alkali metals and alkaline metals. In some embodiments, the inorganic salt is a salt of a transition metal.

Non-limiting examples of inorganic salts include halide salts of a metal selected from Li, K, Ca, Na, Mg, Mn, Zn and others.

The inorganic salts may be halide salts (a halide atom being an anion of the metal cation). In some embodiments, the inorganic salt may be selected from LiCl, NaCl, CaCl₂), CaI₂ and MgCl₂. In some embodiments, the inorganic salt is CaCl₂). In some embodiments, the salt is a calcium salt, e.g., CaCl₂), CaI₂, etc.

The invention further provides the following compositions for making a polymeric film or product according to the invention:
1) PVOH in an amount between 57-58.5 wt %, ethylene-polyvinyl alcohol copolymer in an amount between 35 and 40 wt %, and glycerol in an amount between 1.5 and 3 wt %; or
2) PVOH in an amount between 75-85 wt %, ethylene-polyvinyl alcohol copolymer in an amount between 10 and 20 wt %, and glycerol in an amount of 3 wt %; polyethylene glycol in an amount of 2%, BTCA in an amount of 0.2-0.25%, sodium propionate in an amount of 0.04-0.08% and calcium stearate (CaSt) in an amount of 0.4-0.5%.

Compositions of the invention may be converted into a stock form or a concentrate that comprises a preselected selection of materials, in amounts and amount ratios suitable for producing a particular polymeric product.

Compositions of the invention may be converted into compounded forms such as pellets or other solid particulate forms (such as beads) which may be used as such in the manufacturing of a final polymeric product, e.g., polymeric films or polymeric sheets. The pellet or the particulate solid form may be produced by compounding a composition of the invention under preselected conditions. Through the compounding processes, the composition or resin is converted into a form having properties that make it more effective, efficient and uniform and ready for further processing through processes including, e.g., molding or extrusion. The pellets may have any shape, but typically are small, columnar, or cylindrical bodies having flat surfaces such as cubes, rectangular parallelepipeds, etc. The pellets are formed from a homogeneous mixture of the composition of the invention processed as disclosed herein.

Thus, the invention further provides a pellet or a solid material (e.g., beads) formed from a composition of the invention or comprising a composition of the invention.

In some embodiments, the pellet obtained by compounding a composition of the invention comprises crosslinked PVOH, wherein crosslinking comprises crosslinking between PVOH chains; between PVOH and the plasticizer, e.g., glycerol; between PVOH, the plasticizer and the ethylene-polyvinyl alcohol copolymer; between the plasticizer and ethylene-polyvinyl alcohol copolymer or any other components present in the composition.

In some embodiments, compounding comprises thermally treating a composition of the invention to cause one or more of:
blending of the PVOH and the ethylene-polyvinyl alcohol copolymer;
plasticization of PVOH forming hydrogen bonds between PVOH and the plasticizer, e.g., glycerol;
crosslinking between the PVOH and/or other ingredients as mentioned above; and/or
volatilization of water or other low-boiling point components.

The invention further provides a process of manufacturing a pellet from a composition of the invention, the process comprising compounding the composition under conditions selected to convert the composition into a solid particular material.

In some embodiments, the conditions include converting the composition into a molten state, further causing evaporation or partial evaporation of volatiles. The compounding may thus be carried out by extrusion, e.g., on an extruder such as a twin-screw extruder.

In some embodiments, the twin-screw extruder is a co-rotating or counter-rotating extruder.

In some embodiments, compounding comprises use of a kneader and/or a mixer.

In some embodiments, the compounding is achievable by heating the composition, followed by exposing the melt to a mixing process. In some embodiments, the compounding may be carried out on a twin-screw extruder equipped with a devolatilization system suited for causing unreacted monomers, solvent, water, dissolved gases, or other undesirable volatile materials to be removed from a polymer melt.

Pellets or solid particulate materials formed by compounding compositions of the invention may be used in a manufacturing of a polymeric object, e.g., polymeric films or sheets, by further processing the pellet or solid particulate material by, e.g., molding or extrusion. Thus, in another aspect of the invention, there is provided use of a composition of the invention for manufacturing a polymeric product, such as a polymeric film or a polymeric sheet.

The invention further provides a process of manufacturing a polymeric product such as a film or a sheet, wherein the process comprises transforming, e.g., by molding or extruding, a compounded form of a composition of the invention into the polymeric product.

In some embodiments, the process comprises extruding a compounded form of a composition of the invention.

In some embodiments, the compounded form of the composition is a pelletized form.

In some embodiments, the pelletized form is obtained by compounding as disclosed herein. In some embodiments, compounding is carried out by converting the composition into a molten state, further causing evaporation or partial evaporation of volatiles. The compounding may be carried out by extrusion, e.g., on an extruder such as a twin-screw extruder. In some embodiments, the twin-screw extruder is a co-rotating or counter-rotating extruder. In some embodiments, compounding comprises use of a kneader and/or a mixer. In some embodiments, the compounding is achievable heating the composition, followed by exposing the melt to a mixing process. In some embodiments, the compounding may be carried out on a twin-screw extruder equipped with a devolatilization system suited for causing unreacted monomers, solvent, water, dissolved gases, or other undesirable volatile materials to be removed from a polymer melt.

In some embodiments, the process of manufacturing a polymeric product such as a film or a sheet, comprises compounding a composition of the invention into a pellet form and transforming, e.g., by molding or extruding the pellet form, into the polymeric product.

In some embodiments, the process comprises:
providing a composition according to the invention;
compounding said composition into a pellet; and
transforming the pellet into the polymeric product.

The transformation of the compounded form, e.g., pellet, into the polymeric product may be achievable by molding or by extrusion, including injection molding. Depending on the size and shape of the polymeric product, a proper technique may be utilized. Where the product is a film or a sheet, the transformation may comprise blown film extrusion or cast film extrusion.

In some embodiments, the films or sheets are manufactured by blown film extrusion. In the process, the compounded material of the invention, often in form of pellets or beads, is loaded into a hopper and fed into a heated barrel with a screw. The pellets are gradually heated to melt the polymer, when the molten material is subsequently extruded through a die. Different dies may be used; one such die is an annular die or a ring-shaped die. The molten polymer enters the die head and air is injected via a hole in the die center to radially inflate the polymer into a thin tube that is many times its extruded diameter. The film thickness and width may be adjusted in order to meet a desired film profile. Following extrusion, the hot tube film is cooled and pulled by, e.g., nip rollers. As the film cools it flattens and transported for further processing.

The blown film extrusion process may be used to produce a wide variety of products, ranging from simple monolayer films to complex multilayer structures used, e.g., in food packaging.

In some embodiments, the films or sheets are manufactured by a cast film extrusion process, whereby differently from the blown extrusion process, the molten polymer is fed through a flat die system to adopt its final flat film shape. For coextrusion, a die system may comprise a die and a feedblock and for a monolayer extrusion a flat die may be used.

The orientation of the polymer film or sheet may be determined or modified by a tenter frame, a double bubble or machine direction orientation.

Once formed, the films can be further modified by roll slitting, coating or printing, and physical vapor deposition to make metallized films. Films can also be subjected to corona treatment or plasma processing and can have release agents applied as desired.

In some embodiments, the films can be thermoformed, stretched, compression molded, and/or laminated.

In some embodiments, the extruded films are oriented while being stretched.

The oriented films or shrinkable films of the invention can be of any thickness depending on the desired end-use. For some uses, where the films and/or shrinkable films are intended be printed with ink for applications such as labels which can be adhered to substrates such as paper, the thickness of the film may be smaller as compared to shrinkable protective films. In some embodiments, the films have a thickness of between 10 microns and 500 microns, or 25 and 500 microns, or 50 and 500 microns, or 100 microns and 500 microns, 150 microns and 500 microns, 200 microns and 500 microns, 250 microns and 500 microns, 300 microns and 500 microns, 350 microns and 500 microns, 400 microns and 500 microns, or 450 microns and 500 microns.

In some embodiments, the films may be provided in a thickness between 10 microns and 100 microns, 10 microns and 90 microns, 10 microns and 80 microns, 10 microns and 70 microns, 10 microns and 60 microns, 10 microns and 50 microns, 10 microns and 40 microns, 10 microns and 30 microns, 10 microns and 20 microns, 20 microns and 100 microns, 30 microns and 100 microns, 40 microns and 100 microns, 50 microns and 100 microns, 60 microns and 100 microns, 70 microns and 100 microns, 80 microns and 100 microns, 90 microns and 100 microns, 30 microns and 90 microns, 30 microns and 80 microns, 30 microns and 70 microns, 30 microns and 60 microns, or between 30 microns and 50 microns.

In some embodiments, the films may be provided in a thickness between 10 microns and 200 microns, 10 microns and 300 microns, or 10 microns and 400 microns.

Multilayer films may similarly be manufactured by blown film coextrusion that combines two or more molten polymer materials.

In some embodiments, a film formed according to the invention is a multilayer film comprising two or more layers of same or different compositions. The multilayer film may be a coextruded, wherein, for example, at least one layer is of a composition according to the invention or prepared according to the invention, and at least one other is a polymeric or non-polymeric film of a different composition. A multilayer film may be a coextruded multi-layer blown film alternatively comprising at least three layers: at least one layer of a polymeric or non-polymeric material and two or more layers, each being selected independently amongst compositions disclosed herein, e.g., differing in the ethylene content or the plasticizer used or the PVOH grade used.

According to some embodiments, the multilayer film comprises from 2 to 20 layers, wherein at least one of the layers is a layer formed of a compounded composition according to the invention. The multilayer may be of the form AB, ABA, BAB, AABB . . . etc, such that at least one of said A or B layers is a layer film of the invention.

A multilayer film may be produced by conventional means, including for example co-extrusion. In some cases, a multilayer film may be produced by coextrusion from two or more extruders, each extruder being designated to extrude an extrudable composition that is to form one of the layers.

The polymeric films of the invention may be used in a wide variety of applications, including packaging, plastic bags, labels, shrinkable labels, electrical fabrication, photographic film, film stock for films, and others.

As used herein with regard to films of the invention, the term “film” includes both film and sheet, encompasses the commonly accepted meaning in the art. The term includes single layer and multilayer films.

Films of the invention have been determined to exhibit superior properties as compared to similar films not formed of PVOH and E-PVA, as disclosed. Films of the invention have demonstrated:
superior water biodegradability and improved-water resistance over time;
surprisingly reduced oxygen transmittance rate (OTR), thus presenting superior oxygen barrier properties
improved water resistance
improved Coefficient of Friction (CoF); According to the test method for CoF below, obtained CoF values of <0.35 with the invention, especially and consistently at EPVA use levels >20%.
improved tackiness; According to the test method for tackiness below, obtained tackiness levels of <0.25 N/cm with the invention, especially and consistently at EPVA use levels >20%.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1: Exemplary analysis of absolute biodegradation percentages of reference compositions (based on O₂ consumption). The improvements are calculated based on the plateau regions of the graphs.

FIG. 2: OTR values are in units of cm³/m²*day, for 50-micron films and demonstrate a reduction in OTR values as compared to films formed of compositions not containing E-PVA.

FIG. 3: A spider chart demonstrating the unique properties of compositions of the invention.

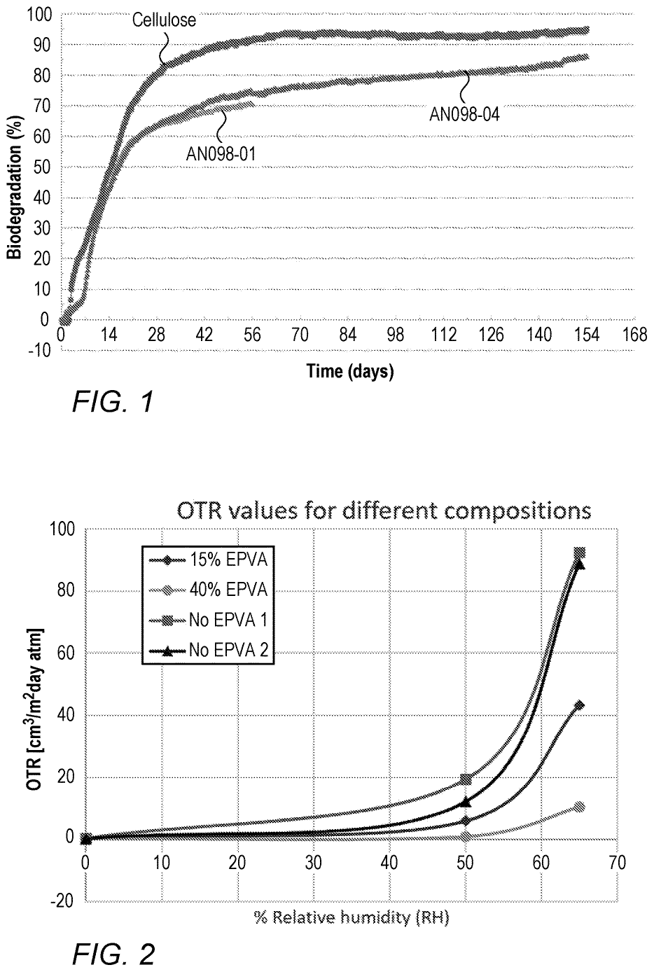

### DETAILED DESCRIPTION OF EMBODIMENTS

### Preparation of Compositions of the Invention

A dry partially hydrolyzed PVOH with an average degree of polymerization 800-1400, see below or a combination of various PVOH grades (for example partially hydrolyzed with DP 800 together with partially hydrolyzed PVOH with DP 1400) were mixed while a plasticizer (such as glycerol) was added. Once the mixture was heated, ethylene-polyvinyl alcohol copolymer was added and mixed for a period of (approximately 15 minutes to obtain a premix. Additives (crosslinkers, slip agents and others) were subsequently added to the premix.

A twin-screw extruder was heated to a temperature around 205° C. using a flat temperature profile. At the indicated temperature, the premix was added to the feeder and the process was run at 350 RPM and changed according to process stability.

Pellets were obtained and were subsequently used in a film blowing process.

Examples of specific material combinations used are listed in Table 1 below.

### Film Blowing:

The pellets were put in the feeder and the process was run at a temperature of 200° C. (all zones). When the formed balloon was stable and the film was at the required quality, it was rolled or wound and collected.

Films produced from the plasticized blends of polyvinyl alcohol (PVOH), and ethylene-polyvinyl alcohol copolymer showed superior properties in terms of surface properties (i.e., reduced coefficient of Friction (CoF) and tackiness), water resistance and biodegradability, in comparison to film produced with no ethylene-polyvinyl alcohol copolymer. Using crosslinkers enables to significantly reduce the quantity of ethylene-polyvinyl alcohol copolymer without compromising water resistance and surface properties.

Compositions of the invention as well as films made therefrom have been tested and their properties measured. Table 1 lists compositions and their measured properties.

TABLE 1
Compositions and properties of films made therefrom. Properties were
determined on monolayer films with nominal thickness of 50 microns.

| | | | | | | | | ethylene | |
|---|---|---|---|---|---|---|---|---|---|
| | PVOH | PVOH | EPVA | EPVA | | | | maleic | |
| | Grade | Grade | Grade | Grade | Succinic | | Sodium | anhydride | |
| Composition | 1 | 2 | 1 | 2 | Acid | BTCA | Propionate | copolymer | Glycerol |
| 1 | 45-47 | | 50 | | | | | | 3-5 |
| | wt % | | wt % | | | | | | wt % |
| 2 | 57-58.5 | | 40 | | | | | | 1.5-3 |
| | wt % | | wt % | | | | | | wt % |
| 3 | 67-68.5 | | 30 | | | | | | 1.5-3 |
| | wt % | | wt % | | | | | | wt % |
| 4 | | 45-47 | | 50 | | | | | 3-5 |
| | | wt % | | wt % | | | | | wt % |
| 5 | | 57-58.5 | | 40 | | | | | 1.5-3 |
| | | wt % | | wt % | | | | | wt % |
| 6 | | 67-68.5 | | 30 | | | | | 1.5-3 |
| | | wt % | | wt % | | | | | wt % |
| 7 | 45-51 | 30-34 | 10-20% | | | | | | 3 |
| | wt % | wt % | | | | | | | wt % |
| 8 | 45-51 | 30-34 | 10-20% | | 0.06-0.2 | | | | 3 |
| | wt % | wt % | | | wt % | | | | wt % |
| 9 | 45-51 | 30-34 | 10-20% | | | 0.2-0.25% | 0.04-0.08 | | 3 |
| | wt % | wt % | | | | | wt % | | wt % |
| 10 | 45-51 | 30-34 | 10-20% | | | | | 0.1-0.3 | 3 |
| | wt % | wt % | | | | | | wt % | wt % |
| 11 | 41-47 | 27-31 | 10-20% | | 0.15-0.2% | | | | 10% |
| | wt % | wt % | | | | | | | |
| 12 | 62 | 26 | 0% | 0% | | | | | 12 |
| (ref.) | wt % | wt % | | | | | | | wt % |

| | | | Water | | | Biodegrad- | Water |
|---|---|---|---|---|---|---|---|
| Composition | PEG | CaSt | degradation | COF | Tackiness | ability | resistance |
| 1 | | | Very | Low | Very | Very | Very |
| | | | Slow | | Low | fast | high |
| 2 | | | Very | Low | Low | Fast | Very |
| | | | Slow | | | | high |
| 3 | | | Very | Medium | Medium | Fast | Very |
| | | | Slow | | | | high |
| 4 | | | Very | Low | Very | | |
| | | | Slow | | Low | | |
| 5 | | | Very | Low | Low | | |
| | | | Slow | | | | |
| 6 | | | Very | Medium | Medium | | |
| | | | Slow | | | | |
| 7 | 2 | | Medium | High | High | Medium | Low |
| | wt % | | | | | | |
| 8 | 2 | 0.24-0.6 | Very | Low | Very | Medium | Medium |
| | wt % | wt % | slow | | low | | |
| 9 | 2 | 0.4-0.5 | Medium | Low | Low | Medium | Medium |
| | wt % | wt % | | | | | |
| 10 | 2 | 0.4-0.6 | Slow | Low | Very | Medium | Medium |
| | wt % | wt % | | | low | | |
| 11 | 2% | 0.35-0.37% | Medium- | Medium | Medium | Medium | Low |
| | | | fast | | | | |
| 12 | | | Fast | High | High | Medium | Very |
| (ref.) | | | | | | to slow | low |

Composition 7 of Table 1 was prepared by mixing the PVOH, E-PVA and plasticizers in a high-speed mixer. Two grades of PVA were added to the mixer at the designated ratio (45/30), afterwards the plasticizers were added (3 wt % glycerol, 3 wt % PEG). The mixing process was initiated and the E-PVA was added after the premix started to be powdery. The mixing process was continued until the temperature of the premix started to rise and the mixture turned into a homogeneous dry powder. The final premix was put in a feeder of a compounder unit to start the compounding process, in which the material was heated and converted into a melt and then cooled to strands and cut to pellets. The pellets were then converted into films by blown film extrusion.

In a similar fashion, all compositions and products of the invention have been prepared.

All surface property tests were performed on the films as described in the sections below.

Biodegradability was tested on pellets after cryogenic milling. A respirometer (Echo Instruments, model E12/1.4) was used to measure the CO₂ production of the samples which were put in an aqueous solution inoculated with sludge from a local wastewater treatment facility (undefined and unfiltered), in accordance with ISO14851 and ISO14852 measurement methods.

### Water Degradation (Disintegration and Dissolution)

Test protocol: A 50 micron film (3*3 cm²) was incubated in a vessel with water (250 ml) at 30° C. in an orbital shaker and the visual appearance in terms of disintegration and dissolution was evaluated according to a predetermined table of values below.

The time of disintegration and/or dissolution of the films was graded as follows, at the point in time in which particles >2 mm are no longer visually apparent:
Very fast—few minutes
Fast—<1 hour
Medium—<24 hours
Slow—2-4 days
Very slow—More than 5 days

### Coefficient of Friction (CoF): ASTM D1894-14

Test protocol: Using standard mechanical tensile testing equipment, a weight is dragged on the surface at a fixed speed of 150 mm/minute. Both the weight and the surface are covered in the tested film. The weight is typically 200 grams and the drag distance is typically 150 mm. The CoF is the force of friction acting on an object divided by the normal force acting on the same object and is dimensionless. The results are graded as follows:

$$Low CoF < 0.25$$

$$Medium CoF - 0.25 - 0.35$$

$$High CoF -> 0.35$$

### Tackiness:

Test protocol: Following exposure to specified humidity and temperature conditions, two separate sections of films are laminated together via pressing without heating. The peel force to separate the two films is then measured. The force is correlated to a tackiness level as listed below.

Test conditions: Films were first placed inside a humidity chamber at 38° C. and 75% RH for one hour. They were then removed from the chamber and left for one minute at ambient conditions and then laminated in a ExcelamII-3550 tabletop roll laminator (used here without heat, only fixed pressure and speed). Afterward, they were left under ambient conditions for an additional 30 minutes before testing the peel force. Peel force was measured using standard mechanical tensile testing equipment. The results are graded as follows:

Very low tackiness (not tacky)—The films do not adhere following the lamination process.

$$Low tackiness - < 0.1 N / cm$$

$$Medium tackiness - 0.1 - 0.25 N / cm$$

$$High tackiness -> 0.25 N / cm$$

### Biodegradability:

Biodegradation in a water-sludge environment was tested according to ISO 14851 or ISO 14852. Biodegradation in the table above is defined as 90% in comparison to microcrystalline cellulose (determined as carbon in evolved CO₂ relative to calculated total organic carbon (TOC). Biodegradation is rated as follows:
Very fast—14-21 days
Fast—21-56 days
Medium—56-120 days
Slow—120-180 days

### Water Resistance (Time to Deformation):

Water resistance is evaluated as time to film deformation after 3 drops of water (each drop ~100-110 μl) are sequentially dropped on a 50-micron film that is placed in a horizontal position. The time until the film starts deforming is measured.

The water resistance grading is indicated as follows:
Very Low: 1-15 seconds
Low: 15-30 seconds
Medium: 30-60 seconds
High: 1-15 minutes
Very high: more the 15 minutes

### Processability:

| Component | PVOH | E-PVA | Crosslinker* | Glycerol | PEG | Processability |
|---|---|---|---|---|---|---|
| 1 | 75-85 wt % | 10-20% | 0% | 3 wt % | 2 wt % | Moderate |
| 2 | 95 wt % | 0% | 0.2-0.25 wt % | 3 wt % | 2 wt % | Not good |
| 3 | 75-85 wt % | 10-20 wt % | 0.2-0.25 wt % | 3 wt % | 2 wt % | Good |

*Each of the three different crosslinkers were tested in separate compositions: Succinic acid, BTCA and ethylene maleic anhydride copolymer.

Processability is graded as follows:
Good: stable process/pressure and torque in compounding and blowing.
Moderate: Strands in compounding process have some bubbles. The process is not very stable (torque overloads/high pressure . . . ).
Not good: Compounds could not be produced due to poor melt quality and torque overloads and very high number of bubbles. There are no films from these compounds.

### Barrier Against Oxygen and CO₂ Transmission

Gas barrier is defined here by oxygen transmission rate (OTR), as may be expressed in units of cm³/m²*day through a film with defined thickness, where the lower the OTR values for a given thickness, the better the barrier. Gas transmission of carbon dioxide is typically 3-5 times that of oxygen transmission for a given film and film thickness.

In water sensitive materials, oxygen barrier properties are typically dependent on % relative humidity. It was found that as EVPA concentration increases, the dependency of OTR on humidity decreases, and the OTR values at specific RH values are lower relative to compositions without EPVA (FIG. 2).

As the presented results demonstrate, polymers formed from compositions of the invention exhibit low tackiness, low CoF, high water resistance (long time to deformation) and a high biodegradability rate. These properties are significantly improved for all E-PVA comprising compounds mentioned above (relative to composition 12 which is a reference composition that comprises no E-PVA.

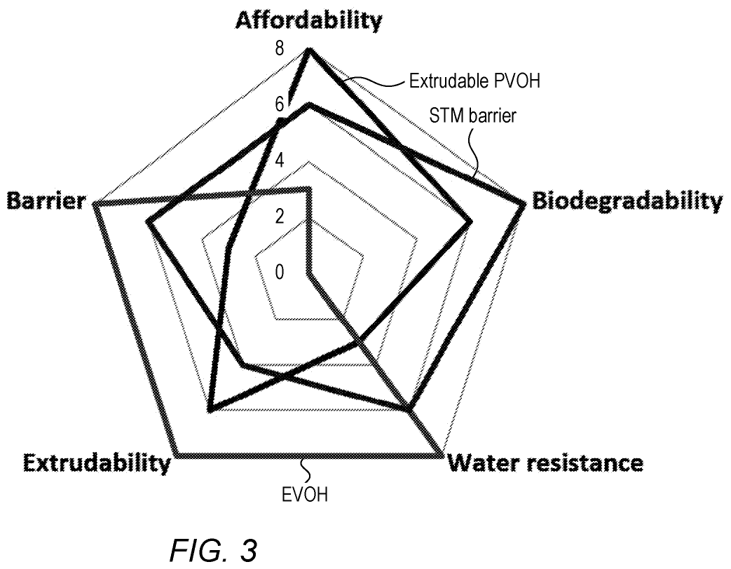

The spider chart presented in FIG. 3 demonstrates the ability to achieve a wide range of desired properties by using E-PVA comprising compounds mentioned herein. Although EVOH, a widely used barrier material, has very good extrudability and excellent barrier properties, it is not soluble, not biodegradable and has a relatively high cost. As opposed to EVOH, extrudable PVOH has low barrier properties and low water resistance but is affordable and generally biodegradable. E-PVA comprising compounds have the benefits of both EVOH and extrudable PVOH. The compositions show good extrudability, good barrier, affordability, water resistance and biodegradability, as demonstrated in the spider chart.

1.-47. (canceled)

48. A composition comprising polyvinyl alcohol (PVOH), ethylene-polyvinyl alcohol copolymer, a plasticizer and optionally a crosslinking agent.

49. The composition according to claim 48, in a compounded form.

50. The composition according to claim 48 in a pelletized form or in a form of a polymer sheet or polymer film.

51. The composition according to claim 48, wherein the PVOH is a single grade of PVOH or a combination of grades.

52. The composition according to claim 51, wherein the PVOH is selected amongst hydrolyzed PVOH having a degree of hydrolysis ranging between 86 and 99%; or wherein the PVOH is selected amongst PVOH having a degree of polymerization ranging between 500 and 3,000; or wherein the PVOH is a partially hydrolyzed PVOH with a degree of polymerization between 300 and 2,000; or wherein the PVOH has a degree of polymerization between 800 and 1400 or a molecular weight between 30 KDa and 70 KDa or a molecular weight between 35 KDa and 62 KDa.

53. The composition according to claim 48, wherein the PVOH is one or more of:
(i) Grade 1: partially hydrolyzed grade having a degree of hydrolysis from 86 to 90% and a degree of polymerization (DP) of between 300 and 2000, or between 500 and 1400,
(ii) Grade 2: medium hydrolyzed grade having a degree of hydrolysis between 91 and 97%, and
(iii) Grade 3: fully hydrolyzed grade having a degree of hydrolysis from 98% to >99% (or 100%) and a degree of polymerization of between 300 and 2000, or 500 and 1700.

54. The composition according to claim 48, wherein the ethylene-polyvinyl alcohol copolymer (E-PVA) having an ethylene content not exceeding 15 molar %.

55. The composition according to claim 48, wherein the E-PVA is one or more of:
(1) Grade 1: a degree of polymerization (DP) between 300 and 800;
(2) Grade 2: a degree of polymerization (DP) between 800 and 1500; and
(3) Grade 3: a degree of polymerization (DP) between 1500 and 2000.

56. The composition according to claim 48, wherein:
the PVOH is one or more of the following grades:
(i) partially hydrolyzed grades having a degree of hydrolysis from 86 to 90% and a degree of polymerization (DP) of between 300 and 2000, or between 500 and 1400,
(ii) medium hydrolyzed grades having a degree of hydrolysis between 91 and 97%, and
(iii) fully hydrolyzed grades having a degree of hydrolysis from 98% to >99% (or 100%) and a degree of polymerization of between 300 and 2000, or 500 and 1700,
the E-PVA is one or more of the following:
(i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000,
(ii) E-PVA having a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5%.

57. The composition according to claim 48, wherein:
the PVOH being a partially hydrolyzed grade having a degree of hydrolysis from 86 to 90% and a degree of polymerization (DP) of between 300 and 2000, or between 500 and 1400, and
the E-PVA is selected from:
(i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000, and
(ii) E-PVA having a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5%.

58. The composition according to claim 48, wherein:
the PVOH is a medium hydrolyzed grade having a degree of hydrolysis between 91 and 97%, and
the E-PVA is selected from:
(i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000, and
(ii) E-PVA having a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5%.

59. The composition according to claim 48, wherein:
the PVOH is a fully hydrolyzed grade having a degree of hydrolysis from 98% to >99% (or 100%) and a degree of polymerization of between 300 and 2000, or 500 and 1700, and
the E-PVA is selected from:
(i) E-PVA having a DP that is between 300 and 1,500, 300 and 1,000, 300 and 900, 300 and 800, 300 and 700, 300 and 600, 300 and 500, 500 and 2,000, 500 and 1,500, 500 and 1,000, 500 and 900, 500 and 800, 1,000 and 2,000, 1,000 and 1,500, or a DP that is about (±10%) 300, 400, 500, 600, 700, 800, 900, 1,000, 1,100, 1,200, 1,300, 1,400, 1,500, 1,600, 1,700, 1,800, 1,900 or 2,000, and
(ii) E-PVA having a DH that is between 86 and 99, 86 and 95, 86 and 90, 90 and 99.5, 95 and 99.5 or a DH that is about (±10%) 86, 87, 88, 89, 90, 91, 92, 93, 94, 95, 96, 97, 98, 99 or 99.5%.

60. The composition according to claim 48, wherein the plasticizer is selected amongst such materials capable of reducing a glass transition temperature and/or melting point of the composition under melt extrusion.

61. A pelletized solid composition comprising or formed of a composition according to claim 48.

62. A film or a multi-film structure comprising a composition according to claim 48.

63. The film according to claim 62, wherein the composition comprises a blend of PVOH, E-PVA, a plasticizer and optionally at least one additive.

64. The film according to claim 62, having an improved biodegradation of at least 15%, when measured according to ISO14851 or ISO14852, as compared to biodegradation of PVOH-based products not containing E-PVA, measured under identical conditions.

65. The film according to claim 62, having a water resistance to water, measured as a time to film deformation after contacting the film with about 300 μl of water, wherein the film deformation is more than 15 minutes.

66. The film according to claim 62, having oxygen transmission rate (OTR) of between 6 cm³/m²*day and 0.9 cm³/m²*day, when measured at 50% relative humidity.

67. A process of manufacturing a polymeric film or sheet, the process comprising transforming by molding or extruding a compounded form of a composition according to claim 48 into the polymeric film or sheer.
